(19) United States
(12) Patent Application Publication
(10) Pub. No.: US 2025/0285268 A1
(43) Pub. Date: Sep. 11, 2025

(54) MEDICAL IMAGE PROCESSING DEVICE, HIERARCHICAL NEURAL NETWORK, MEDICAL IMAGE PROCESSING METHOD, AND PROGRAM

(71) Applicant: FUJIFILM Corporation, Tokyo (JP)

(72) Inventor: Shumpei KAMON, Kanagawa (JP)

(73) Assignee: FUJIFILM Corporation, Tokyo (JP)

(21) Appl. No.: 19/061,950

(22) Filed: Feb. 24, 2025

(30) Foreign Application Priority Data
Mar. 5, 2024 (JP) 2024-033022

(51) Int. Cl. G06T 7/00; G06T 7/11; G06V 10/25; G06V 10/82

(52) U.S. Cl. CPC G06T 7/0012; G06T 7/11; G06V 10/25; G06V 10/82; G06T 2207/20132

(57) ABSTRACT

There are provided a medical image processing device, a hierarchical neural network, a medical image processing method, and a program capable of achieving highly accurate and real-time processable region-of-interest detection and class classification. A medical image processing device acquires a medical image, extracts a first feature amount and a second feature amount having a resolution relatively higher than a resolution of the first feature amount from the medical image by processing the medical image in a feature extraction network of a hierarchical neural network, detects a region of interest included in the medical image by processing the first feature amount in a first subnetwork of the hierarchical neural network, and classifies the region of interest by processing the second feature amount in a second subnetwork of the hierarchical neural network.

### CROSS-REFERENCE TO RELATED APPLICATION

The present application claims priority under 35 U.S.C § 119(a) to Japanese Patent Application No. 2024-033022 filed on Mar. 5, 2024, which is hereby expressly incorporated by reference, in its entirety, into the present application.

### BACKGROUND OF THE INVENTION

### 1. Field of the Invention

The present invention relates to a medical image processing device, a hierarchical neural network, a medical image processing method, and a program, and particularly relates to a technique of detecting and classifying a region of interest from a medical image.

### 2. Description of the Related Art

A function of detecting a region of interest such as a lesion from a medical image captured by a medical image diagnostic apparatus such as an endoscope and an ultrasound diagnostic apparatus and simultaneously classifying the region of interest into a class such as a disease type is known. Such a function can be implemented by training a neural network (NN) using an image including the region of interest and position information and classification class information of the region of interest (see WO2020/203552A and WO2019/142243A).

During inference, feature extraction is performed while gradually reducing a resolution of an input image using NN processing, and the region detection and classification are performed from the obtained feature amount. In the classification task, the classification processing is performed after cropping a part corresponding to the detection region from the feature amount reduced in resolution. Therefore, a processing target in the classification task has a small feature resolution, which leads to a decrease in accuracy in a case in which it is necessary to evaluate a detailed structure such as lesion classification. In particular, in a model designed for real-time processing, this problem is conspicuous because it is necessary to actively reduce the resolution for high-speed processing.

### SUMMARY OF THE INVENTION

As a method of solving such a problem, a method of cropping a detection region from an input image and training a classification task using the cropped image is considered. However, it is inefficient to perform the feature extraction using the NN processing again from a high-resolution input image, which may make the real-time processing difficult.

The present invention has been made in view of such circumstances, and an object of the present invention is to provide a medical image processing device, a hierarchical neural network, a medical image processing method, and a program capable of achieving highly accurate and real-time processable region-of-interest detection and class classification.

In order to achieve the above object, a first aspect of the present disclosure provides a medical image processing device comprising: one or more processors that acquire a medical image; and one or more memories that store a program to be executed by the one or more processors, in which the one or more processors extract a first feature amount and a second feature amount having a resolution relatively higher than a resolution of the first feature amount from the medical image by processing the medical image in a feature extraction network of a hierarchical neural network including the feature extraction network, a first subnetwork, and a second subnetwork, detect a region of interest included in the medical image by processing the first feature amount in the first subnetwork of the hierarchical neural network, and classify the region of interest by processing the second feature amount in the second subnetwork of the hierarchical neural network.

A second aspect of the present disclosure provides the medical image processing device according to the first aspect, in which it is preferable that the second feature amount is an intermediate feature amount in a process of extracting the first feature amount from the medical image in the feature extraction network.

A third aspect of the present disclosure provides the medical image processing device according to the first or second aspect, in which it is preferable that the one or more processors train the first subnetwork using a first data set and train the second subnetwork using a second data set, the first data set includes a set of a first medical image and position information of a region of interest included in the first medical image, and the second data set includes a set of a second medical image and position information and a classification class label of a region of interest included in the second medical image.

A fourth aspect of the present disclosure provides the medical image processing device according to the third aspect, in which it is preferable that the one or more processors train the feature extraction network and the first subnetwork using the first data set, and train the second subnetwork using the second data set based on the trained feature extraction network and the trained first subnetwork.

A fifth aspect of the present disclosure provides the medical image processing device according to the fourth aspect, in which it is preferable that the one or more processors pre-train the feature extraction network using a third data set different from the first data set and the second data set before training the feature extraction network and the first subnetwork using the first data set.

A sixth aspect of the present disclosure provides the medical image processing device according to any one of the first to fifth aspects, in which it is preferable that the one or more processors notify of position information of the region of interest in a manner corresponding to a result of the classification.

A seventh aspect of the present disclosure provides the medical image processing device according to the sixth aspect, in which it is preferable that the one or more processors add information based on the position information to the medical image and display the medical image on a display.

An eighth aspect of the present disclosure provides the medical image processing device according to the sixth or seventh aspect, in which it is preferable that the one or more processors do not notify of the position information of the region of interest in a case in which the result of the classification is a specific class.

A ninth aspect of the present disclosure provides the medical image processing device according to the eighth aspect, in which it is preferable that classes of the classification include a malignancy grade, and the one or more processors do not notify of the position information of the region of interest in a case in which the malignancy grade is relatively low.

A tenth aspect of the present disclosure provides the medical image processing device according to any one of the first to ninth aspects, in which it is preferable that the one or more processors crop a part of the second feature amount according to a detection result of the region of interest, and process the cropped second feature amount in the second subnetwork.

An eleventh aspect of the present disclosure provides the medical image processing device according to the tenth aspect, in which it is preferable that the one or more processors align a size of the cropped second feature amount in a spatial direction to a certain size, and process the second feature amount having the certain size in the second subnetwork.

In order to achieve the above object, a twelfth aspect of the present disclosure provides a hierarchical neural network comprising: a feature extraction network that extracts a first feature amount and a second feature amount having a resolution relatively higher than a resolution of the first feature amount from an input medical image; a first subnetwork that detects a region of interest included in the medical image from the input first feature amount; and a second subnetwork that classifies the region of interest from the input second feature amount.

In order to achieve the above object, a thirteenth aspect of the present disclosure provides a medical image processing method executed by one or more processors, the medical image processing method comprising: acquiring a medical image; extracting a first feature amount and a second feature amount having a resolution relatively higher than a resolution of the first feature amount from the medical image by processing the medical image in a feature extraction network of a hierarchical neural network including the feature extraction network, a first subnetwork, and a second subnetwork; detecting a region of interest included in the medical image by processing the first feature amount in the first subnetwork of the hierarchical neural network; and classifying the region of interest by processing the second feature amount in the second subnetwork of the hierarchical neural network.

In order to achieve the above object, a fourteenth aspect of the present disclosure provides a program for causing a computer to execute the medical image processing method according to the thirteenth aspect. The present disclosure also includes a non-transitory computer-readable storage medium in which the program according to the thirteenth aspect is stored.

According to the present invention, it is possible to achieve highly accurate and real-time processable region-of-interest detection and class classification.

### BRIEF DESCRIPTION OF THE DRAWINGS

FIG. 1 is a conceptual diagram of a network system that performs general detection processing.

FIG. 2 is a conceptual diagram of a network system in which detection and classification are performed using separate NNs.

FIG. 3 is a conceptual diagram of a network system according to a first embodiment.

FIG. 4 is a flowchart showing steps of a medical image processing method.

FIG. 5 is a block diagram showing a configuration of a medical image processing device.

FIG. 6 is a schematic diagram showing an overall configuration of an endoscope system including the medical image processing device.

### DESCRIPTION OF THE PREFERRED EMBODIMENTS

Hereinafter, preferred embodiments of the present invention will be described with reference to the accompanying drawings. The same components are denoted by the same reference numerals, and overlapping description will not be repeated.

### General Detection Processing

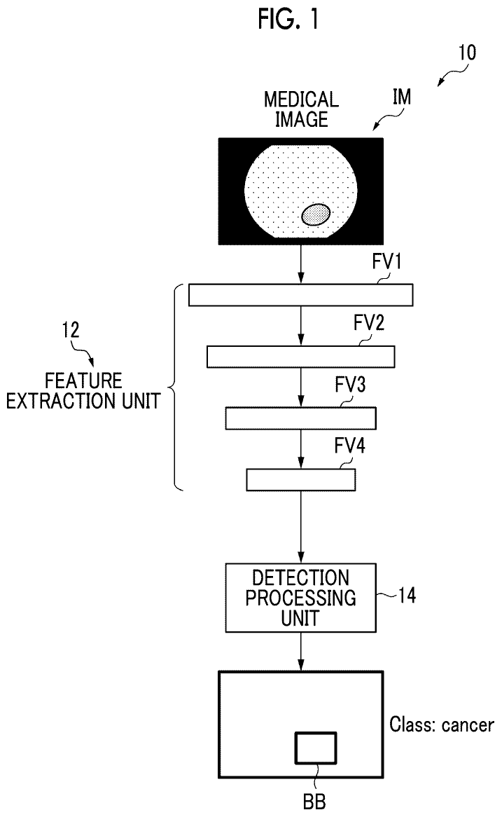

FIG. 1 is a conceptual diagram of a network system 10 that performs general detection processing. The network system 10 includes a feature extraction unit 12 and a detection processing unit 14.

The feature extraction unit 12 is an NN that outputs a feature amount of an image in a case in which the image is input. In the example shown in FIG. 1, the feature extraction unit 12 receives a medical image as an input image IM as an input and outputs a feature amount of the input image IM. In FIG. 1, an arrow represents NN processing, FV1, FV2, FV3, and FV4 represent feature amounts of a processing process, and horizontal widths of FV1, FV2, FV3, and FV4 represent a size of a resolution in a spatial direction. The feature extraction unit 12 extracts features of the input image IM while gradually decreasing the resolution of the feature amount. The feature amount extracted by the feature extraction unit 12 is input to the detection processing unit 14.

The detection processing unit 14 is an NN that simultaneously outputs a position of a lesion, which is a region of interest of the image, and class classification of the lesion in a case in which the feature amount of the image is input. In the example shown in FIG. 1, the detection processing unit 14 receives the feature amount FV4 extracted by the feature extraction unit 12 as an input, and outputs a bounding box BB indicating the position of the lesion in the input image IM and a result of the class classification of the lesion, “Class: cancer”.

In the network system 10, it is necessary to perform the class classification of the region of interest based on the feature amount having a relatively low resolution, which leads to a decrease in accuracy in a task such as lesion classification in which a detailed structure of the surface needs to be evaluated.

### Detection Processing of Performing Detection and Classification Separately

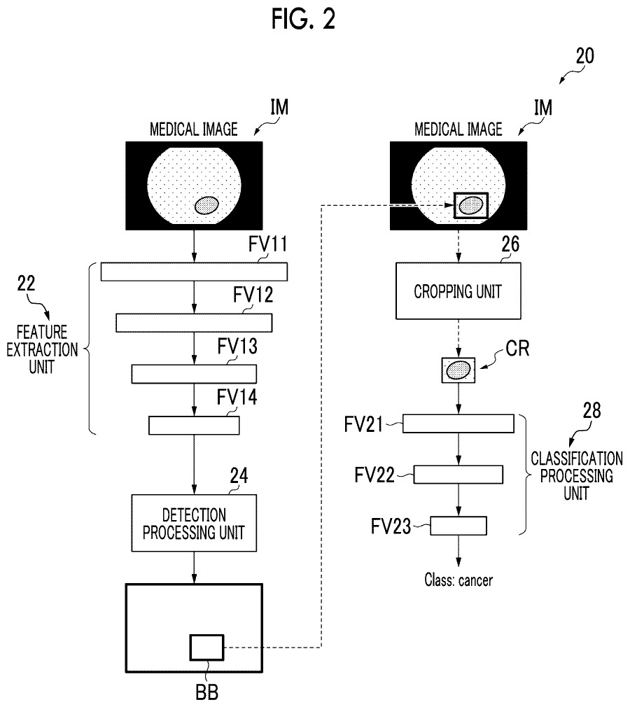

As a method of increasing the resolution during classification, there is a method of performing detection and classification in separate NNs. FIG. 2 is a conceptual diagram of a network system 20 in which detection and classification are performed in separate NNs. The network system 20 includes a feature extraction unit 22, a detection processing unit 24, a cropping unit 26, and a classification processing unit 28.

The feature extraction unit 22 is an NN that outputs a feature amount of an image in a case in which the image is input. In the example shown in FIG. 2, the feature extraction unit 22 receives a medical image as an input image IM as an input and outputs a feature amount of the input image IM. In FIG. 2, a solid arrow represents NN processing, FV11, FV12, FV13, and FV14 represent feature amounts of a processing process, and horizontal widths of FV11, FV12, FV13, and FV14 represent a size of a resolution in a spatial direction. The feature extraction unit 22 extracts features of the input image IM while gradually decreasing the resolution of the feature amount. The feature amount extracted by the feature extraction unit 22 is input to the detection processing unit 24.

The detection processing unit 24 is an NN that outputs only the position of the lesion of the image in a case in which the feature amount of the image is input. In the example shown in FIG. 2, the detection processing unit 24 receives the feature amount FV14 extracted by the feature extraction unit 22 as an input, and outputs a bounding box BB indicating the position of the lesion in the input image IM.

In a case in which the input image IM and the bounding box BB are input, the cropping unit 26 generates a cropped region CR obtained by cropping a region surrounded by the bounding box BB from the input image IM.

The classification processing unit 28 is an NN that outputs class classification of a disease type of the lesion included in the cropped region in a case in which the cropped region of the image is input. In the example shown in FIG. 2, the cropped region CR is input, and a result of the class classification of the lesion, “Class: cancer”, is output. In FIG. 2, a solid arrow represents NN processing, FV21, FV22, and FV23 represent feature amounts of a processing process, and horizontal widths of FV21, FV22, and FV23 represent a size of a resolution in a spatial direction.

With the network system 20, the problem of the resolution in the classification processing is solved. However, since it is necessary to perform the feature extraction again from the input image IM in the classification processing unit 28, the calculation efficiency is poor, and it is inappropriate in a situation where real-time processing is required.

### First Embodiment

### Configuration of Network System

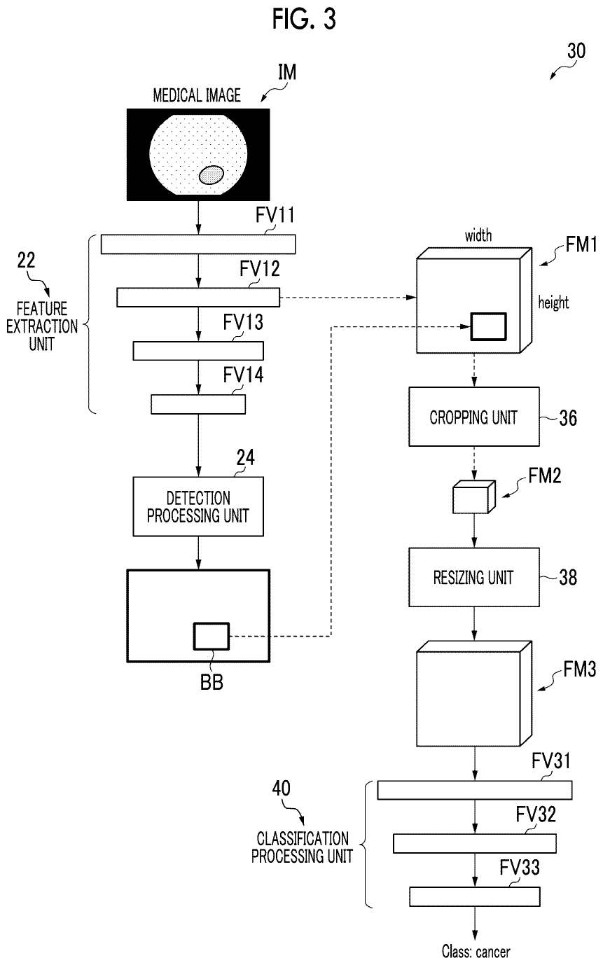

FIG. 3 is a conceptual diagram of a network system 30 according to a first embodiment. The network system 30 includes a feature extraction unit 22, a detection processing unit 24, a cropping unit 36, a resizing unit 38, and a classification processing unit 40.

The feature extraction unit 22 is an NN that extracts a first feature amount and a second feature amount having a resolution relatively higher than a resolution of the first feature amount from the input medical image. The second feature amount may be an intermediate feature amount in a process of extracting the first feature amount from the input image through the feature extraction unit 22. The resolution of the second feature amount need only be decided in consideration of a trade-off between the accuracy of the classification of the lesion and the time required for the classification. The feature extraction unit 22 holds an intermediate feature amount in a calculation process while estimating only position information of the lesion, which is a region of interest, through the detection processing. In the example shown in FIG. 3, FV14 corresponds to the first feature amount, and FV12 corresponds to the second feature amount.

The detection processing unit 24 is an NN that outputs only the position of the lesion of the image in a case in which the feature amount of the image is input. In the example shown in FIG. 3, the detection processing unit 24 receives the feature amount FV14 as the first feature amount as an input, and outputs a bounding box BB indicating the position of the lesion in the input image IM.

The cropping unit 36 crops a part of the second feature amount according to a detection result of the region of interest, and generates a feature map by cropping a region corresponding to the bounding box BB from a feature map indicated by the feature amount in a case in which the feature amount of the image and the bounding box BB are input. In the example shown in FIG. 3, the cropping unit 36 receives a feature map FM1 indicated by the feature amount FV12 which is the second feature amount and the bounding box BB as an input, and outputs a feature map FM2 obtained by cropping a region corresponding to the bounding box BB from the feature map FM1.

The feature map FM1 is two-dimensional data having a size of width in a horizontal direction and a size of height in a vertical direction. The feature map FM1 indicates a feature amount of the input image IM in which the position information in the input image IM is reflected. The feature map FM2 indicates a feature amount of the lesion in the input image IM.

The resizing unit 38 generates a feature map FM3 by aligning a size of the input feature map FM2 in the spatial direction to a constant size by interpolation processing or the like. The certain size is, for example, a size suitable for input to the classification processing unit 40.

The classification processing unit 40 is an NN that classifies the disease type of the lesion from the input feature amount. In the example shown in FIG. 3, the classification processing unit 40 receives the feature map FM3 as an input, and outputs a result of the class classification of the lesion included in the feature map FM3, “Class: cancer”. In FIG. 3, a solid arrow represents NN processing, FV31, FV32, and FV33 represent feature amounts of a processing process, and horizontal widths of FV31, FV32, and FV33 represent a size of a resolution in a spatial direction. The classification processing unit 40 may perform class classification of the malignancy grade of the lesion.

As described above, the network system 30 includes a hierarchical neural network comprising the feature extraction unit 22 which is a feature extraction network, the detection processing unit 24 which is a first subnetwork, and the classification processing unit 40 that is a second subnetwork.

### Medical Image Processing Method

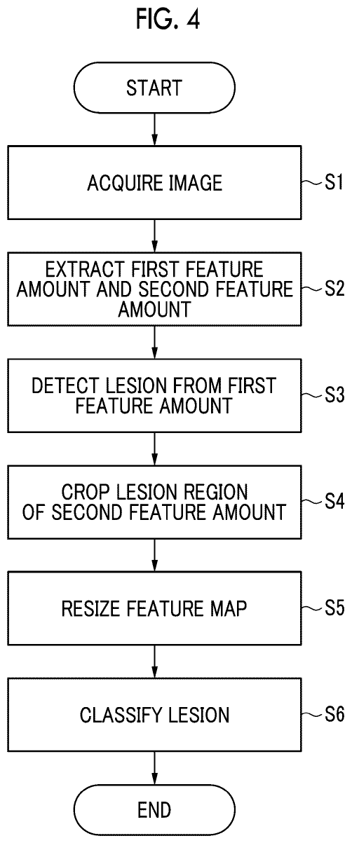

FIG. 4 is a flowchart showing steps of a medical image processing method using the network system 30.

In step S1, the network system 30 acquires a medical image. In the example shown in FIG. 3, the input image IM is acquired.

In step S2, the network system 30 extracts a first feature amount and a second feature amount having a resolution relatively higher than a resolution of the first feature amount by processing the medical image acquired in step S1 in the feature extraction unit 22. In the example shown in FIG. 3, FV14 is extracted as the first feature amount, and FV12 is extracted as the second feature amount.

In step S3, the network system 30 detects the lesion included in the medical image by processing the first feature amount extracted in step S2 in the detection processing unit 24. In the example shown in FIG. 3, the bounding box BB indicating the position of the lesion of the input image IM is output.

In step S4, the network system 30 crops the region of the lesion detected in step S3 from the second feature amount extracted in step S2 by using the cropping unit 36. In the example shown in FIG. 3, the feature map FM2 is cropped.

In step S5, the network system 30 resizes the feature map cropped in step S4 to a certain size by using the resizing unit 38. In the example shown in FIG. 3, the feature map FM3 is generated.

In step S6, the network system 30 performs class classification of the lesion detected in step S3 by processing the feature map resized in step S5 in the classification processing unit 40. That is, the network system 30 performs class classification of the lesion by processing the second feature amount. In the example shown in FIG. 3, the result of the class classification of the lesion, “Class: cancer”, is output.

As described above, according to the medical image processing method, the intermediate feature amount of the feature extraction unit 22 is used instead of cropping from the input image IM. This method enables classification processing based on the feature amount having a higher resolution than the network system 10, and does not require the feature extraction using the NN processing again from the input image as in the network system 20. As a result, it is possible to achieve both high accuracy and real-time processing. In addition, the network system 30 performs the classification processing after aligning the sizes of the feature maps in the spatial direction, so that it is possible to reduce the influence of the size difference of the region of interest.

Here, the second feature amount is the intermediate feature amount in the process of extracting the first feature amount from the input image through the feature extraction unit 22, but the method of extracting the second feature amount is not limited to this example. For example, in the feature extraction unit 22 having decoding processing of increasing a resolution, such as U-net, the resolution may be increased from the first feature amount to generate the second feature amount. In addition, in the feature extraction unit 22 where the NN branches in the middle, the first feature amount and the second feature amount may be extracted separately.

### Training of Hierarchical Neural Network

For training of the hierarchical neural network consisting of the feature extraction unit 22, the detection processing unit 24, and the classification processing unit 40, a plurality of sets of learning data sets in which a training image and correct answer data are combined are used.

The training image may be, for example, a medical image. The medical image may be, for example, an endoscope image, a computed tomography (CT) image, a magnetic resonance imaging (MRI) image, and an ultrasound image.

The correct answer data includes position information of a region of interest included in the training image and classification label information of the region of interest.

The detection processing unit 24 may be trained using a first data set, and the classification processing unit 28 may be trained using a second data set different from the first data set. The first data set includes a set of a first medical image and position information of a region of interest included in the first medical image, and the second data set includes a set of a second medical image and position information and a classification class label of a region of interest included in the second medical image.

The training of the detection processing unit 24 requires a pair of the training image and the position information of the region of interest, and the training of the classification processing unit 40 further requires information on a classification label of the region of interest. In a case in which the entire hierarchical neural network is trained using the same data set, it is necessary to prepare correct answer data for all training images. On the other hand, in a method of separately training the detection processing unit 24 and the classification processing unit 40 by using different data sets, it is not necessary to add classification labels to all data. It is sufficient to train only the detection processing unit 24 by using the learning data set to which the position information is added as the correct answer data, and to train the classification processing unit 40 by using only the learning data set to which the classification label is added as the correct answer data.

In a case of performing learning in two stages as described above, it is desirable to train the feature extraction unit 22 and the detection processing unit 24 first, and then train the classification processing unit 40 in a state where learned weights are transferred to the feature extraction unit 22 and the detection processing unit 24. That is, the feature extraction unit 22 and the detection processing unit 24 are trained using the first data set, and the classification processing unit 28 is trained using the second data set based on the trained feature extraction unit 22 and the trained detection processing unit 24.

Before training the feature extraction unit 22 and the detection processing unit 24, the feature extraction unit 22 may be pre-trained using a third data set different from the first data set and the second data set. The third data set includes a set of an image and a result of a task of the image. The image is not limited to a medical image and may be a general image. One advantage of the general image is that it is easier to obtain a large amount of data than the medical image. In addition, the task is not limited to the detection task and may be a classification task.

### Configuration of Medical Image Processing Device

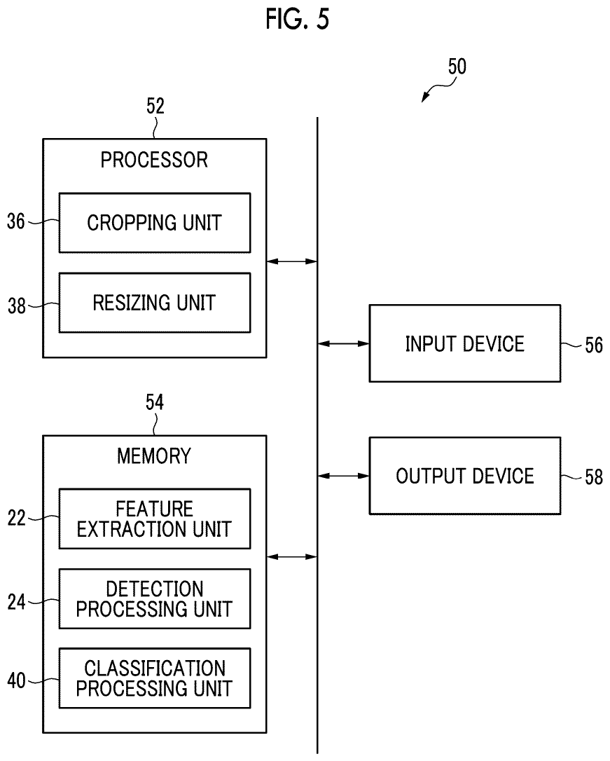

FIG. 5 is a block diagram showing a configuration of a medical image processing device 50 to which the network system 30 is applied. The medical image processing device 50 is implemented by at least one computer. As shown in FIG. 5, the medical image processing device 50 comprises a processor 52, a memory 54, an input device 56, and an output device 58.

The processor 52 acquires a medical image and executes a command stored in the memory 54. A hardware structure of the processor 52 is various processors as shown below. The various processors include a central processing unit (CPU) that is a general-purpose processor acting as various functional units including the cropping unit 36 and the resizing unit 38 by executing software (program), a graphics processing unit (GPU) that is a processor specialized in image processing, a programmable logic device (PLD) that is a processor of which a circuit configuration is changeable after manufacturing, such as a field programmable gate array (FPGA), a dedicated electric circuit that is a processor having a circuit configuration dedicatedly designed to execute a specific process, such as an application specific integrated circuit (ASIC), or the like.

One processing unit may be configured of one of these various processors, or may be configured of two or more processors of the same type or different types (for example, a plurality of FPGAs, a combination of a CPU and an FPGA, or a combination of a CPU and a GPU). Further, a plurality of functional units may be configured of one processor. As an example in which the plurality of functional units are configured of one processor, first, as typified by a computer such as a client or a server, one processor is configured of a combination of one or more CPUs and software and this processor acts as the plurality of functional units. Second, as typified by a system on chip (SoC) or the like, a processor that realizes the functions of the entire system including the plurality of functional units with one integrated circuit (IC) chip is used. As described above, the various functional units are configured by using one or more of the above described various processors as a hardware structure.

The hardware structure of these various processors is more specifically an electric circuit (circuitry) in which circuit elements such as semiconductor elements are combined.

The memory 54 stores a command to be executed by the processor 52. In addition, the memory 54 stores a program and a weight parameter for causing the NN of each of the feature extraction unit 22, the detection processing unit 24, and the classification processing unit 40 to function. The memory 54 includes a random access memory (RAM) and a read only memory (ROM), neither of which is shown. The processor 52 executes various types of processing of the medical image processing device 50 by using the RAM as a work region, executing software by using various programs and parameters stored in the ROM, and using the parameters stored in the ROM and the like.

The medical image processing method shown in FIG. 4 is implemented by the processor 52 executing a medical image processing program stored in the memory 54. The medical image processing program may be provided by a computer-readable non-transitory storage medium. In this case, the medical image processing device 50 may read the medical image processing program from the non-transitory storage medium and store the medical image processing program in the memory 54.

The medical image processing device 50 may train the hierarchical neural network by the processor 52 executing a learning program stored in the memory 54. The learning data set may be stored in the memory 54. The hierarchical neural network may be trained by a computer different from the medical image processing device 50. In this case, a program and a weight parameter for causing the trained NN to function need only be stored in the memory 54.

The input device 56 is configured of, for example, a keyboard, a mouse, a touch panel, or other pointing devices, or a voice input device, or an appropriate combination thereof. A doctor can input various instructions and information to the medical image processing device 50 using the input device 56.

The output device 58 includes a display device. For example, the display device may be a liquid crystal display, an organic electro-luminescence (OEL) display, a projector, or an appropriate combination thereof. The input device 56 and the display device of the output device 58 may be integrally configured, such as a touch panel. In addition, the output device 58 may include a voice output device such as a speaker that outputs a voice. The medical image processing device 50 can output the result of the processing of the detection and the class classification of the lesion to the output device 58 and notify the doctor of the result using image information or a voice.

### Second Embodiment

In a case in which the medical image processing device 50 notifies the doctor of the result of the processing of the detection and the class classification of the lesion using the image information or the voice, the doctor may be notified of the result in different aspects according to the classification result. For example, in a case in which the medical image processing device 50 displays a figure indicating the position of the lesion together with the input image on the display device, the medical image processing device 50 makes at least one of a color, a line type, a thickness, the presence or absence of blinking, a blinking frequency, or the number of times of blinking of the figure different according to the classification result. The medical image processing device 50 may make a type of the figure different according to the classification result. The type of the figure may be a rectangular frame (bounding box) surrounding the lesion, a circular frame surrounding the lesion, a plurality of parentheses surrounding the lesion, an arrow indicating the lesion, or the like. In addition, in a case in which the medical image processing device 50 outputs a voice indicating the position of the lesion to the voice output device, the medical image processing device 50 makes at least one of a volume, a pitch, the presence or absence of repetition, a cycle of repetition, or the number of times of repetition of the voice different according to the classification result.

In addition, the medical image processing device 50 may be configured not to provide a notification only in a case of specific class classification. For example, in a case of lesion detection, only a lesion with a relatively low malignancy grade is left unnotified, whereby it is possible to reduce the adverse effect of information with a relatively low degree of importance interfering with a doctor's diagnosis.

### Third Embodiment

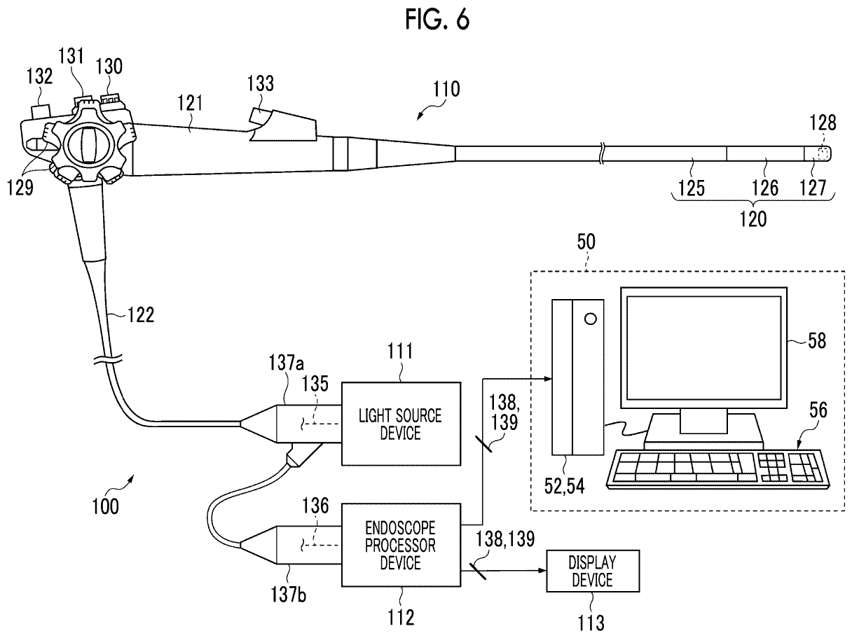

An application example of the medical image processing device 50 in which both high accuracy and real-time processing are achieved for the detection and classification of the lesion will be described. FIG. 6 is a schematic diagram showing an overall configuration of an endoscope system 100 including the medical image processing device 50. As shown in FIG. 6, the endoscope system 100 comprises the medical image processing device 50, an endoscope 110 that is an electronic endoscope, a light source device 111, an endoscope processor device 112, and a display device 113.

The endoscope 110 is used for capturing a medical image which is a time-series image, and is, for example, a flexible endoscope. The endoscope 110 includes an insertion part 120 that is inserted into a subject and that has a distal end and a base end, a hand operation part 121 that is consecutively installed on a base end side of the insertion part 120 and that is held by a doctor for performing various operations, and a universal cord 122 that is consecutively installed with the hand operation part 121.

The insertion part 120 is formed in an elongated shape with a small diameter as a whole. The insertion part 120 is configured by consecutively installing, in order from the base end side to a distal end side, a flexible portion 125 that has flexibility, a bendable portion 126 that can be bent by operating the hand operation part 121, and a distal end portion 127 that incorporates an imaging optical system (not shown), an imaging element 128, and the like.

The imaging element 128 is a complementary metal oxide semiconductor (CMOS) type imaging element or a charge coupled device (CCD) type imaging element. Image light of an observed part is incident on an imaging surface of the imaging element 128 via an observation window (not shown) that is open to a distal end surface of the distal end portion 127, and an objective lens (not shown) disposed behind the observation window. The imaging element 128 images the image light of the observed part incident on its imaging surface and outputs an imaging signal.

Two types of bending operation knobs 129 that are used for the bending operation of the bendable portion 126, an air/water supply button 130 for an air/water supply operation, and a suction button 131 for a suction operation are disposed in the hand operation part 121. In addition, the hand operation part 121 is provided with a still image capturing instruction unit 132 for giving an imaging instruction of a still image 139 of the observed part and a treatment tool inlet port 133 through which a treatment tool (not shown) is inserted into a treatment tool insertion passage (not shown) passing through the insertion part 120.

The universal cord 122 is a connection cord for connecting the endoscope 110 to the light source device 111. The universal cord 122 encompasses a light guide 135, a signal cable 136, and a fluid tube (not shown) which are inserted into the insertion part 120. In addition, a connector 137a that is connected to the light source device 111, and a connector 137b that branches from the connector 137a and that is connected to the endoscope processor device 112 are disposed in an end part of the universal cord 122.

By connecting the connector 137a to the light source device 111, the light guide 135 and the fluid tube are inserted into the light source device 111. Accordingly, necessary illumination light, water, and gas are supplied from the light source device 111 to the endoscope 110 via the light guide 135 and the fluid tube. As a result, illumination light is emitted from an illumination window (not shown) on the distal end surface of the distal end portion 127 toward the observed part. In addition, a gas or water is jetted from an air/water supply nozzle (not shown) on the distal end surface of the distal end portion 127 toward an observation window (not shown) on the distal end surface according to a pressing operation of the air/water supply button 130 described above.

By connecting the connector 137b to the endoscope processor device 112, the signal cable 136 and the endoscope processor device 112 are electrically connected to each other. Accordingly, via the signal cable 136, the imaging signal of the observed part is output from the imaging element 128 of the endoscope 110 to the endoscope processor device 112, and a control signal is output from the endoscope processor device 112 to the endoscope 110.

The light source device 111 supplies the illumination light to the light guide 135 of the endoscope 110 via the connector 137a. As the illumination light, white light which is light in a white wavelength range or light in a plurality of wavelength ranges, light in one or a plurality of specific wavelength ranges, or light in various wavelength ranges according to an observation purpose, such as a combination of these, is selected. Note that the specific wavelength range is a range narrower than the white wavelength range.

A first example of the specific wavelength range is, for example, a blue or green range of visible range. The wavelength range of the first example includes a wavelength range of 390 nm or more and 450 nm or less or 530 nm or more and 550 nm or less, and light of the first example has a peak wavelength in the wavelength range of 390 nm or more and 450 nm or less or 530 nm or more and 550 nm or less.

A second example of the specific wavelength range is, for example, a red range of the visible range. The wavelength range of the second example includes a wavelength range of 585 nm or more and 615 nm or less or 610 nm or more and 730 nm or less, and light of the second example has a peak wavelength in the wavelength range of 585 nm or more and 615 nm or less or 610 nm or more and 730 nm or less.

A third example of the specific wavelength range includes a wavelength range of which a light absorption coefficient is different between oxygenated hemoglobin and reduced hemoglobin, and light of the third example has a peak wavelength in the wavelength range of which the light absorption coefficient is different between the oxygenated hemoglobin and the reduced hemoglobin. The wavelength range of the third example includes a wavelength range of 400±10 nm, 440±10 nm, 470±10 nm, or 600 nm or more and 750 nm or less, and light of the third example has a peak wavelength in the wavelength range of 400±10 nm, 440±10 nm, 470±10 nm, or 600 nm or more and 750 nm or less.

A fourth example of the specific wavelength range is a wavelength range (390 nm to 470 nm) of excitation light that is used for observing (fluorescence observation) fluorescence emitted by a fluorescent substance in a living body and that excites the fluorescent substance.

A fifth example of the specific wavelength range is a wavelength range of infrared light. The wavelength range of the fifth example includes a wavelength range of 790 nm or more and 820 nm or less or 905 nm or more and 970 nm or less, and light of the fifth example has a peak wavelength in the wavelength range of 790 nm or more and 820 nm or less or 905 nm or more and 970 nm or less.

The endoscope processor device 112 controls an operation of the endoscope 110 via the connector 137b and the signal cable 136. In addition, the endoscope processor device 112 generates a video 138, which is a time-series medical image consisting of time-series frame images including a subject image, based on the imaging signal acquired from the imaging element 128 of the endoscope 110 via the connector 137b and the signal cable 136. A frame rate of the video 138 is, for example, 30 frames per second (fps).

Further, in a case in which the still image capturing instruction unit 132 is operated by the hand operation part 121 of the endoscope 110, the endoscope processor device 112 acquires one frame image of the video 138 in accordance with a timing of imaging instruction, in parallel with the generation of the video 138, and sets the frame image as the still image 139.

The endoscope processor device 112 outputs the generated video 138 and the generated still image 139 to the display device 113 and the medical image processing device 50 in real time.

The endoscope processor device 112 may generate (acquire) a special light image having information on the specific wavelength range based on a normal light image obtained by the white light. The endoscope processor device 112 obtains a signal of the specific wavelength range by performing calculation based on RGB color information of red, green, and blue or CMY color information of cyan, magenta, and yellow, which is contained in the normal light image.

In addition, the endoscope processor device 112 may generate a feature amount image such as a known oxygen saturation image, for example, based on at least one of the normal light image obtained by the white light or the special light image obtained by the light (special light) of the specific wavelength range. In this case, the endoscope processor device 112 functions as a feature amount image generation unit. The video 138 or the still image 139 including the image of the inside of the living body, the normal light image, the special light image, and the feature amount image are medical images obtained by visualizing a result of imaging or measuring a human body for diagnosis and testing purposes based on images.

The display device 113 is connected to the endoscope processor device 112 and displays the video 138 and the still image 139 input from the endoscope processor device 112. The doctor performs a forward and backward operation or the like of the insertion part 120 while checking the video 138 displayed on the display device 113. In a case in which a lesion or the like is found in the observed part, the doctor executes capturing of a still image of the observed part by operating the still image capturing instruction unit 132 and performs a diagnosis, a biopsy, and the like.

With the endoscope system 100 to which the medical image processing device 50 is applied, it is possible to detect and classify a lesion in real time with high accuracy from the video 138 and the still image 139 captured by the imaging element 128 of the endoscope 110.

### Others

Although the hierarchical neural network that performs the detection and the class classification of the lesion from the medical image has been described here, the present disclosure is not limited to the medical image and can be applied to various images. For example, the technique according to the present disclosure can be applied to a case in which a region of interest is detected from an image in which a structure such as a bridge is imaged, and the region of interest is classified into fissuring, peeling, rust, a hole, and the like.

The technical scope of the present invention is not limited to the scope described in the above embodiments. The configurations and the like in each embodiment can be appropriately combined among the respective embodiments without departing from the spirit of the present invention.

### Explanation of References

10: network system
12: feature extraction unit
14: detection processing unit
20: network system
22: feature extraction unit
24: detection processing unit
26: cropping unit
28: classification processing unit
30: network system
36: cropping unit
38: resizing unit
40: classification processing unit
50: medical image processing device
52: processor
54: memory
56: input device
58: output device
100: endoscope system
110: endoscope
111: light source device
112: endoscope processor device
113: display device
120: insertion part
121: hand operation part
122: universal cord
125: flexible portion
126: bendable portion
127: distal end portion
128: imaging element
129: bending operation knob
130: air/water supply button
131: suction button
132: still image capturing instruction unit
133: treatment tool inlet port
135: light guide
136: signal cable
137a: connector
137b: connector
138: video
139: still image
BB: bounding box
FM1, FM2, FM3: feature map
FV1, FV2, FV3, FV4: feature amount
FV11, FV12, FV13, FV14: feature amount
FV21, FV22, FV23: feature amount
S1 to S6: step of medical image processing method

What is claimed is:

1. A medical image processing device comprising:
one or more processors that acquire a medical image; and
one or more memories that store a program to be executed by the one or more processors,
wherein the one or more processors
extract a first feature amount and a second feature amount having a resolution relatively higher than a resolution of the first feature amount from the medical image by processing the medical image in a feature extraction network of a hierarchical neural network including the feature extraction network, a first subnetwork, and a second subnetwork,
detect a region of interest included in the medical image by processing the first feature amount in the first subnetwork of the hierarchical neural network, and
classify the region of interest by processing the second feature amount in the second subnetwork of the hierarchical neural network.

2. The medical image processing device according to claim 1,
wherein the second feature amount is an intermediate feature amount in a process of extracting the first feature amount from the medical image in the feature extraction network.

3. The medical image processing device according to claim 1,
wherein the one or more processors train the first subnetwork using a first data set and train the second subnetwork using a second data set,
the first data set includes a set of a first medical image and position information of a region of interest included in the first medical image, and
the second data set includes a set of a second medical image and position information and a classification class label of a region of interest included in the second medical image.

4. The medical image processing device according to claim 3,
wherein the one or more processors
train the feature extraction network and the first subnetwork using the first data set, and
train the second subnetwork using the second data set based on the trained feature extraction network and the trained first subnetwork.

5. The medical image processing device according to claim 4,
wherein the one or more processors pre-train the feature extraction network using a third data set different from the first data set and the second data set before training the feature extraction network and the first subnetwork using the first data set.

6. The medical image processing device according to claim 1,
wherein the one or more processors notify of position information of the region of interest in a manner corresponding to a result of the classification.

7. The medical image processing device according to claim 6,
wherein the one or more processors add information based on the position information to the medical image and display the medical image on a display.

8. The medical image processing device according to claim 6,
wherein the one or more processors do not notify of the position information of the region of interest in a case in which the result of the classification is a specific class.

9. The medical image processing device according to claim 8,
wherein classes of the classification include a malignancy grade, and
the one or more processors do not notify of the position information of the region of interest in a case in which the malignancy grade is relatively low.

10. The medical image processing device according to claim 1,
wherein the one or more processors
crop a part of the second feature amount according to a detection result of the region of interest, and
process the cropped second feature amount in the second subnetwork.

11. The medical image processing device according to claim 10,
wherein the one or more processors
align a size of the cropped second feature amount in a spatial direction to a certain size, and
process the second feature amount having the certain size in the second subnetwork.

12. A hierarchical neural network comprising:
a feature extraction network that extracts a first feature amount and a second feature amount having a resolution relatively higher than a resolution of the first feature amount from an input medical image;
a first subnetwork that detects a region of interest included in the medical image from the input first feature amount; and
a second subnetwork that classifies the region of interest from the input second feature amount.

13. A medical image processing method executed by one or more processors, the medical image processing method comprising:
acquiring a medical image;
extracting a first feature amount and a second feature amount having a resolution relatively higher than a resolution of the first feature amount from the medical image by processing the medical image in a feature extraction network of a hierarchical neural network including the feature extraction network, a first subnetwork, and a second subnetwork;
detecting a region of interest included in the medical image by processing the first feature amount in the first subnetwork of the hierarchical neural network; and
classifying the region of interest by processing the second feature amount in the second subnetwork of the hierarchical neural network.

14. A non-transitory, computer-readable tangible recording medium which records thereon, a program for causing, when read by a computer, one or more processors of the computer to execute the medical image processing method according to claim 13.
